(19) United States
(12) Patent Application Publication
(10) Pub. No.: US 2005/0039776 A1
(43) Pub. Date: Feb. 24, 2005

(54) Apparatus and method for cleaning semiconductor substrates

(75) Inventors: Hun-Jung Yi, Suwon-si (KR); Sang-Oh Park, Yongin-si (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD

(21) Appl. No.: 10/827,512

(22) Filed: Apr. 19, 2004

(30) Foreign Application Priority Data
Aug. 19, 2003 (KR) 2003-57249

(51) Int. Cl. B08B 3/00; B08B 1/02

(52) U.S. Cl. 134/2; 134/32; 134/33; 134/26; 134/84; 134/135; 134/61

(57) ABSTRACT

An apparatus for cleaning semiconductor substrates includes a chamber having a cleaning room and a drying room disposed over the cleaning room. The cleaning room and the drying room are separated or placed in communication with one another by a separation plate. An exhaust path is formed at a central portion of the separation plate. As de-ionized water (DI water) filling the cleaning room is drained during a dry process, the inside of the drying room is decompressed, and a drying fluid in the drying room flows from the drying room to the cleaning room along the exhaust path.

### PRIORITY STATEMENT

This application claims the priority of Korean Patent Application No. 2003-57249, filed on Aug. 19, 2003 in the Korean Intellectual Property Office, the disclosure of which is incorporated herein in its entirety by reference.

### BACKGROUND

1. Technical Field

The present disclosure relates to an apparatus and method for manufacturing semiconductor devices and, more particularly, to an apparatus and method for cleaning semiconductor substrates.

2. Discussion of Related Art

A wafer cleaning process is required for removing residual chemicals, small particles, and contaminants produced during semiconductor manufacturing processes. Particularly, when high-density integrated circuits are manufactured, a cleaning process is necessary for removing micro-contaminants attached to a surface of a semiconductor wafer.

A conventional wafer cleaning process includes a chemical treating process for etching or stripping contaminants on a wafer by a chemical reaction, a rinse process for rinsing chemically treated wafers using de-ionized (DI) water, and a dry process for drying the rinsed wafers.

A spin dryer apparatus and an isopropyl alcohol (IPA) vapor dryer apparatus have been used to perform the dry process. An example of a spin dryer apparatus is disclosed in U.S. Pat. No. 5,829,156, and an example of an IPA vapor dryer apparatus is disclosed in U.S. Pat. No. 5,054,210.

As integrated circuits increase in complexity, a spin dryer apparatus using centrifugal force decreases in ability to completely remove water drops left at a wafer. Further, the wafer may be reversely contaminated by a vortex that occurs when the wafer is rotated at a high speed.

A disadvantage of the IPA vapor dryer is that watermarks are created on the wafer after the wafer is dried. Further, since the IPA vapor dryer uses IPA at a higher temperature than a flash point, environmental and safety problems arise. When the spin dryer and the IPA vapor dryer are used in combination, a rinse process and a dry process are performed at different units. Therefore, much time is required to transfer the wafer to the respective units.

To overcome the foregoing problems, a marangoni dryer is used in a dry process in which the wafer is not exposed to air after a chemical treating process and a rinse process. A wafer drying apparatus using the marangoni principle is disclosed in Japanese Laid-open Patent Publication No. 10-335299. In the marangoni dryer, a wafer is dried only at a surface contacting an IPA layer formed at a de-ionized (DI) water surface. Thus, water may remain at a portion of the area of the wafer. Since a wafer lower area is less exposed to IPA vapor than a wafer upper area, the wafer lower area is more unstably dried than the wafer upper area.

### SUMMARY OF THE INVENTION

An apparatus for cleaning semiconductor substrates according to an embodiment of the invention includes a chamber and a supporter which is disposed in the chamber and that supports substrates. The chamber has a cleaning room in which the semiconductor substrates are cleaned and a drying room, disposed over the cleaning room, in which the semiconductor substrates are dried. A supply pipe for supplying a drying fluid onto the substrate is provided at an upper portion of the drying room, and a cleaning solution supply pipe for supplying a cleaning solution onto the semiconductor substrates is provided at a lower portion of the cleaning room.

A separation plate is provided which is movable to separate the cleaning room and the drying room or to place the cleaning room and the drying room in communication with one another. An exhaust path of the drying fluid is formed in the separation plate. As the cleaning solution filling the cleaning room is drained to the outside, the inside of the drying room is decompressed and the drying fluid supplied to the drying room flows from the drying room to the cleaning room through the exhaust path of the separation plate.

Alcohol vapor or heated dry gas may be used as the drying fluid. The supply pipe comprises a first supply pipe for supplying alcohol vapor into the drying room and a second supply pipe for supplying a heated dry gas into the drying room.

The cleaning room has an inner bath where the supporter is disposed and an outer bath disposed to surround the upper outer periphery of the inner bath. The cleaning solution overflowing from the inner bath flows into the outer bath, and a drain port is formed at the bottom of the outer bath. An exhaust port is formed at one side of the outer bath, and the drying fluid flowing into the cleaning room along the exhaust path of the separation plate is exhausted to the outside through the exhaust port.

In at least one embodiment of the invention, the apparatus further includes a separation plate moving part for moving the separation plate. The separation plate moving part includes a connecting rod fixedly connected to the separation plate and a driving part for horizontally moving the connecting rod.

In at least one exemplary embodiment, the exhaust path of the separation plate is at least one hole or slit formed in the separation plate. In an exemplary embodiment of the invention, a plurality of holes or slits are formed at the separation plate, and sizes of the holes or widths of the slits are different according to their forming positions. In another exemplary embodiment, a plurality of holes is formed in at least one row at a central portion of the separation plate. The spaces of adjacent holes differ according to their forming positions. Preferably, the semiconductor substrates are disposed at the supporter in a row, and the row direction is vertical to the direction of the processing surfaces of the semiconductor substrates.

An apparatus for cleaning semiconductor substrates according to another exemplary embodiment of the invention includes a chamber having a drying room in which the semiconductor substrates are dried, a supply pipe installed in the drying room that supplies drying fluids onto the semiconductor substrates, and a separation plate constituting a bottom of the drying room. An exhaust path is formed at a central portion of the separation plate. Drying fluids supplied onto the substrate are exhausted from the drying room through the exhaust path.

An apparatus for cleaning semiconductor substrates according to an exemplary embodiment of the invention includes a chamber and a separation plate. The chamber includes a cleaning room in which the semiconductor substrates are cleaned, and a drying room, disposed over the cleaning room, in which the semiconductor substrates are dried. The separation plate is movable between an open position in which the cleaning room is in communication with the drying room and a closed position in which the cleaning room is separated from the drying room.

A method for cleaning semiconductor substrates according to an exemplary embodiment of the invention includes the steps of disposing the semiconductor substrates in the cleaning room, supplying a cleaning solution to the cleaning room to clean the substrates, moving a supporter in which the substrates are placed to the drying room, moving a separation plate, in which an exhaust path is formed, between the cleaning room and the drying room to separate the drying room from the cleaning room, and supplying a drying fluid to the drying room to dry the substrates.

In at least one exemplary embodiment, the step of drying the substrates includes the steps of draining the cleaning solution filling the cleaning room to the outside to decompress the inside of the drying room, and exhausting the drying fluid supplied to the drying room from the drying room along an exhaust path formed in the separation plate. The drying fluid flowing into the cleaning room is exhausted through an exhaust port formed at the sidewall of the cleaning room while the cleaning solution is drained through a drainpipe of the cleaning room. The exhaust port is closed when the cleaning solution is completely drained from the cleaning room, and the drying fluid flowing into the cleaning room is exhausted through the drainpipe of the cleaning room. Preferably, the drainpipe is connected to the bottom of the cleaning room, and the drain of the cleaning solution from the cleaning room is achieved by gravity.

### BRIEF DESCRIPTION OF THE DRAWINGS

The present invention will become more apparent by describing embodiments thereof in detail with reference to the accompanying drawings in which:

FIG. 1 and FIG. 2 are a longitudinal section view and a cross-sectional view, respectively, of a cleaning apparatus according to an exemplary embodiment of the present invention;

FIG. 3 is a perspective view of the supporter shown in FIG. 1.

FIG. 4 is a top plan view of a separation plate according to an exemplary embodiment of the invention;

FIG. 5 is a top plan view of a separation plate according to another exemplary embodiment of the invention;

FIG. 6 is a top plan view of a separation plate according to another exemplary embodiment of the invention;

FIG. 7 is a top plan view of a separation plate according to another exemplary embodiment of the invention;

FIG. 8 is a top plan view of a separation plate according to another exemplary embodiment of the invention;

FIG. 9 is a top plan view of a separation plate according to another exemplary embodiment of the invention;

FIG. 10 is a top plan view of a separation plate according to another exemplary embodiment of the invention;

FIG. 11 is a cross-sectional view showing the flow direction of a drying fluid in a drying room according to an exemplary embodiment of the invention;

FIG. 12 through FIG. 18 are cross-sectional views showing various steps of a cleaning process according to an exemplary embodiment of the invention;

FIG. 19 is a flowchart showing various steps of a cleaning process according to an exemplary embodiment of the present invention; and

FIG. 20 is a flowchart showing various steps of a dry process according to an exemplary embodiment of the present invention.

### DESCRIPTION OF PREFERRED EMBODIMENTS

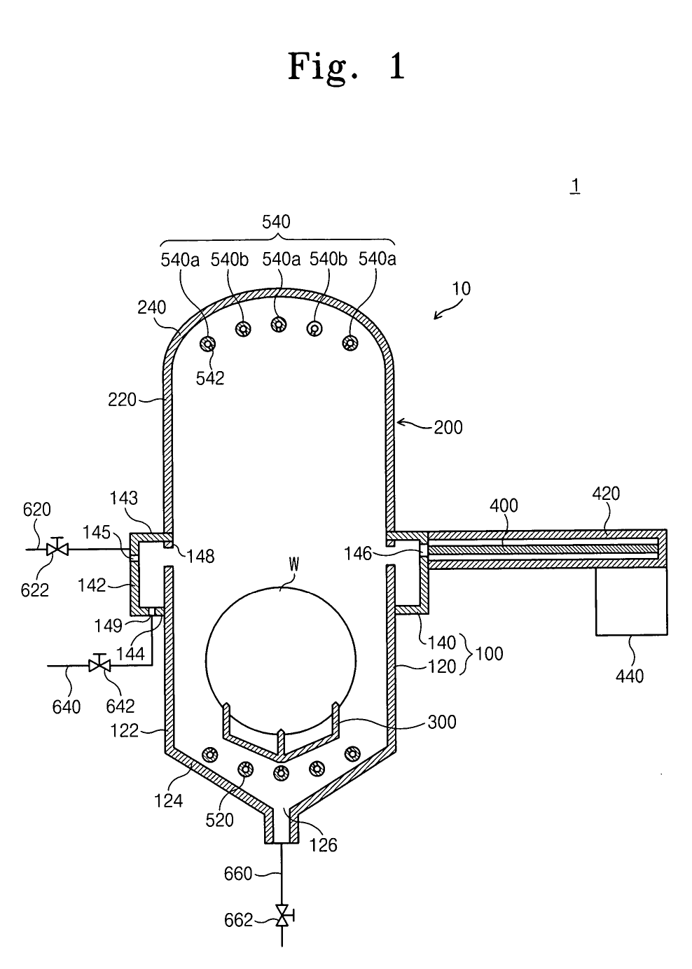

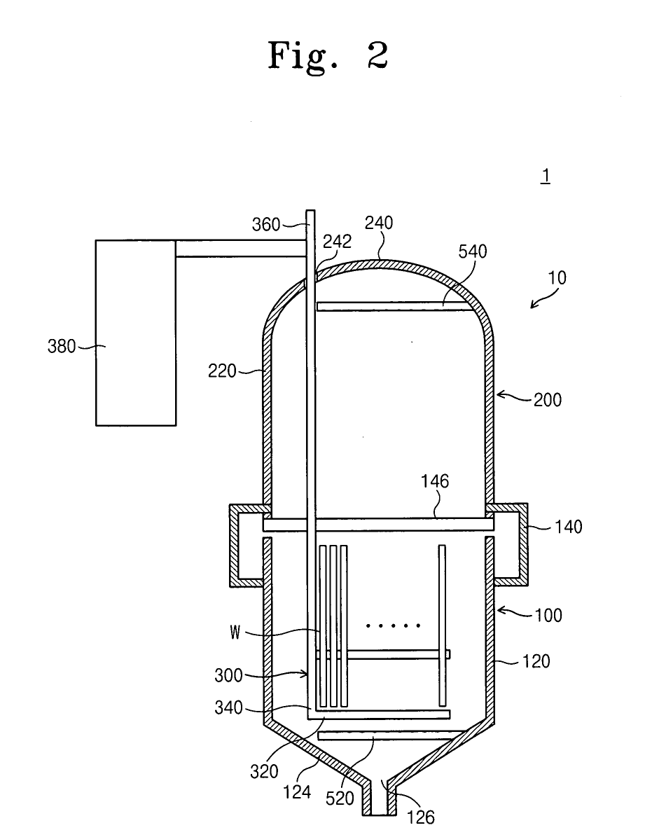

Referring to FIG. 1 and FIG. 2, a cleaning apparatus 1 according to an exemplary embodiment of the present invention includes a chamber 10, a supporter 300, a cleaning liquid supply pipe 520, a drying fluid supply pipe 540, and a separation plate 400. The chamber 10 has a cleaning room 100 and a drying room 200. A chemical treating process and a rinse process are performed in the cleaning room 100, and a dry process is performed in the drying room 200. The cleaning room 100 includes an inner bath 120 in which the supporter 300 is disposed during a process and an outer bath 140, which surrounds the upper outer periphery of the inner bath 120.

The inner bath 140 has an open upper surface, a rectangular parallelepiped sidewall 122, and a bottom 124. An outlet 126 connected to a drainpipe 660 is formed at the center of the bottom 124. The bottom 124 inclinedly tapers down to readily drain a cleaning solution in the inner bath 120. The drainpipe 660 is vertically installed such that the cleaning solution in the inner bath 120 is drained by gravity. An open/close valve 662 is installed at the drainpipe 660 to open/close the path through the drainpipe 660.

The outer bath 140 is fixedly coupled to the inner bath 120. The outer bath 140 is formed in the shape of a rectangular parallelepiped with a thru-hole formed at its center and has a ring-shaped bottom 144 connected to the sidewall 122 of the inner bath 120 and a ring-shaped top 143 disposed at an upper portion of the inner bath 120. The bottom 144 and the top 143 of the outer bath 140 are oppositely disposed. While the outer bath 140 and the inner bath 120 are connected to each other, a determined space is formed between the sidewall 142 of the outer bath 140 and the sidewall 122 of the inner bath 120. A cleaning solution overflowing from the inner bath 120 is contained in the space. An exhaust port 145 is formed at the sidewall 142 of the outer bath 140. A gas flowing from the drying room 200 to the cleaning room 100 is exhausted through the exhaust port 145. An exhaust pipe 620 having an open/close valve 622 is connected to the exhaust port 145. In this case, one pipe or more may be connected to the exhaust pipe 145. A drain port 149 is formed at the bottom 144 of the outer bath 140. A drainpipe 640 for draining the cleaning solution flowing into the outer bath 140 is connected to the drain port 149. An open/close valve 642 is installed at the drainpipe 640 to open/close the path of the drainpipe 640. A ring-shaped projection 148, which is a downwardly projecting part, may be formed at the inner edge of the top 143 of the outer bath 140. The separation plate 400 contacts the projection 148 to separate the drying room 200 from the cleaning room 100. The separation plate 400 will be described in further detail later.

The drying room 200 is disposed on the cleaning room 100. The drying room 200 has a rectangular parallelepiped sidewall 220, a dome-shaped top 240, and an open lower surface. A bottom of the sidewall 220 is disposed on the inner edge of the upper surface 143 of the outer bath 140. An O-ring (not shown) may be inserted into a contact portion of the drying room 200 and the cleaning room 100.

The drying room 200 may be rotated from the cleaning room 100 to allow for disposal of wafers into the cleaning room 100. Optionally, the drying room 200 may be fixedly coupled to the cleaning room 100 and the top 240 of the drying room 200 may be rotatable from the sidewall 220 thereof.

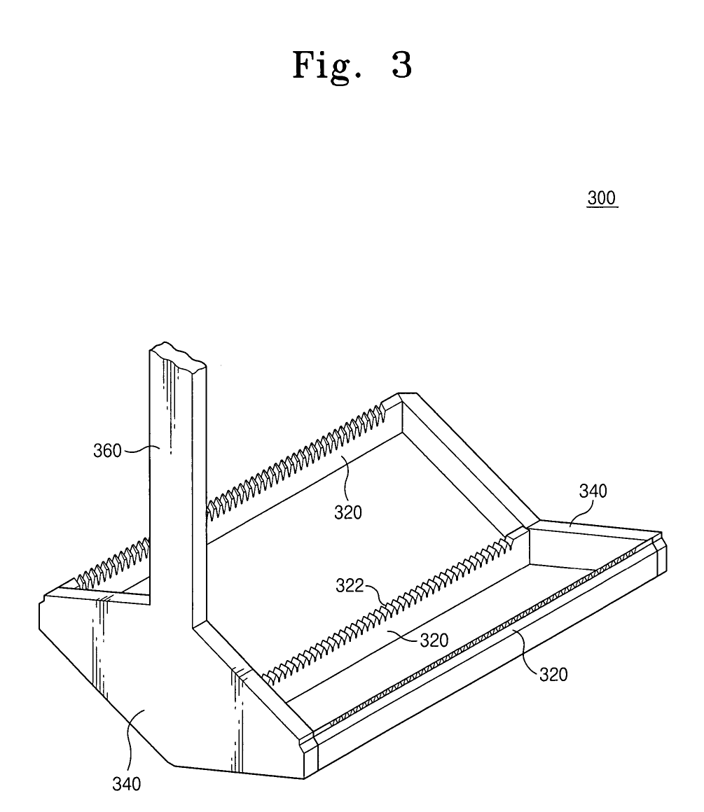

The supporter 300 supports a plurality of wafers “W” that are subjected to a process. Referring to FIG. 3, the supporter 300 includes supporting rods 320, a connecting part 340, and a moving rod 360. Slots 322 are formed at the respective supporting rods 320. The edge of the wafer “W” is partially inserted into the slot 322. That is, the wafers “W” are positioned upright at the supporter 300 to face their processing surfaces. In the present embodiment, there are three supporting rods 320. Approximately 50 wafers may be accommodated at the supporter 300 at one time. The connecting part 340 is disposed at both sides of the supporting rods 320 to connect the supporting rods 320 to each other. The end of the respective supporting rods 320 are fixedly connected to the connecting part 340. The moving rod 360 upwardly extends from the connecting part 340 to an upper portion of the chamber 10 through a hole 242 formed at the top 240 of the drying room 200. A supporter driving part 380 is coupled to a lateral side of the moving rod 360 disposed at the outside of the chamber 10 to move the moving rod 360 up and down. By means of the supporter driving part 380, the supporter 300 is moved up and down to transfer wafers “W” to the cleaning room 100 and the drying room 200. The supporter driving part 380 may be any suitable driving mechanism, such as, for example, a pneumatic or hydraulic cylinder, or a combination part of a motor, rack, and pinion.

The cleaning solution supply pipe 520 is installed in the cleaning room 100. The cleaning solution supply pipe 520 is disposed under the supporter 300 disposed at the cleaning room 100. One cleaning solution supply pipe 520 or more may be installed at the cleaning room 100. The cleaning solution to be used during a chemical treating process may be a chemical solution such as hydrofluoric acid that is suitable to remove particles remaining on wafers “W” and metallic contaminants such as copper or contamination materials such as native oxide. Alternatively, the cleaning solution may be de-ionized (DI) water used to remove a chemical solution remaining on the wafers “W”. The chemical solution and the DI water may be supplied to the cleaning room 100 through the same supply pipe 520. Optionally, a supply pipe for supplying the chemical solution and a supply pipe for supplying the DI water may be individually installed.

The drying fluid supply pipe 540 is installed in the drying room 200 to supply drying fluid. The drying fluid supply pipe 540 is disposed over a wafer “W” transferred to the drying room 200. The drying fluid supply pipe 540 comprises a first supply pipe 540a for supplying alcohol vapor and a second supply pipe 540b for supplying heated dry gas. The first and second supply pipes 540a and 540b are inserted through an outer wall of the drying room 200. An injection port 542 is formed at the respective supply pipes. The injection port 542 comprises a plurality of holes spaced at a regular interval or at different intervals. Alternatively, the injection port 542 may be a slit-type port that is long enough to uniformly inject a drying fluid into all wafers “W”. A plurality of first supply pipes 540a and second supply pipes 540b may be installed to uniformly inject a drying fluid from one side of the wafer “W” to the other side thereof. Further, the alcohol gas and the heated dry gas may be selectively supplied through the same supply pipe.

Isopropyl alcohol (IPA) may be used as the alcohol vapor. Additionally, ethylglycol, 1-propanol, 2-propanol, tetrahydrofurane, 4-hydroxy-4-methyl-pentamone, 1-butanol, 2-butanol, methanol, ethanol, acetone, n-propyl alcohol, dimethylether may be used as the alcohol. The DI water attached onto the wafer “W” in the cleaning room 100 is substituted for IPA vapor supplied to the drying room 200. The wafer is dried by the heated dry gas, such as, for example, nitrogen gas, injected onto the wafer.

Returning to FIG. 1, a space is provided in the chamber 10. A lower space in the chamber 10 is provided by the cleaning room 100, and an upper space in the chamber 10 is provided by the drying room 200. The separation plate 400 separates the upper space from the lower space when a dry process is carried out. When the wafers “W” are disposed in the cleaning room 100, the separation plate 400 is disposed outside of the chamber 10. However, if the wafers “W” are transferred to the drying room 200, the separation plate 400 is moved to the inside of the chamber 10 (between the drying room 200 and the cleaning room 100) to separate the upper space where the dry process is carried out from the lower space where the cleaning process is carried out. A separation plate accommodating part 420 for accommodating the separation plate 400 is fixedly coupled to a sidewall 142 of the outer bath 140 of the cleaning room 100. A slit-type inflow path 146 is formed at the sidewall 142 to which the separation plate accommodating part 420 is coupled. Preferably, the inflow path 146 is formed over the inner bath 120.

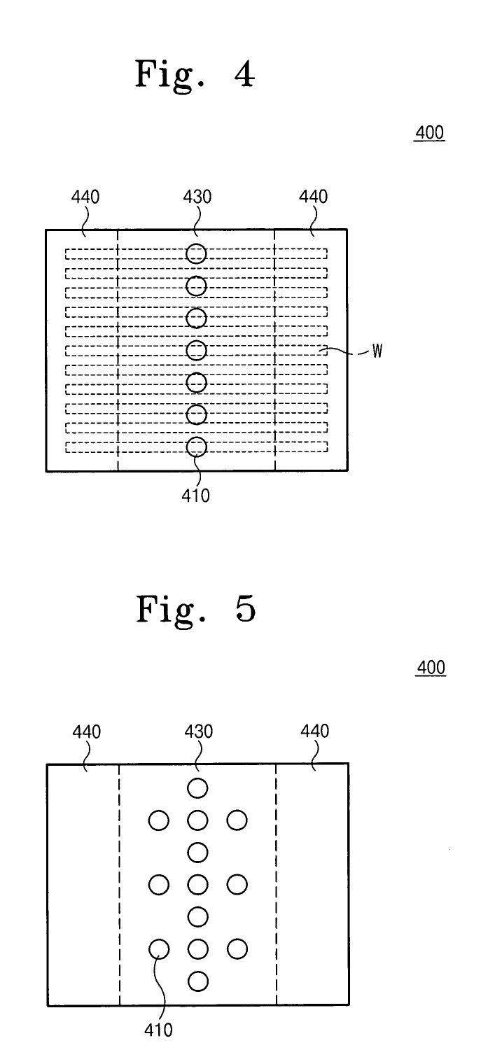

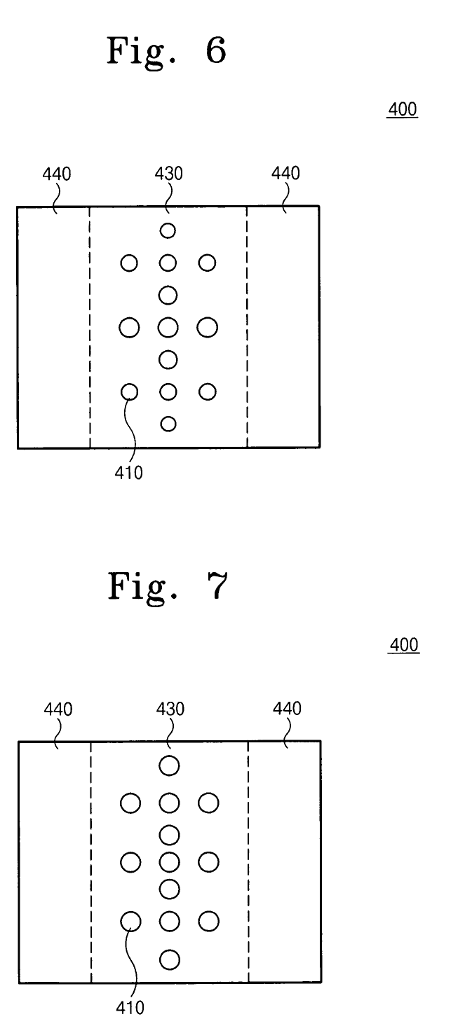

An exemplary embodiment of the separation plate 400 is illustrated in FIG. 4, and various other exemplary embodiments of the separation plate 400 are illustrated in FIG. 5, FIG. 6, and FIG. 7. In FIG. 4, dotted parts denote wafers “W” disposed over the separation plate 400. Referring to FIG. 4, the separation plate 400 is formed in the shape of a rectangular parallelepiped and is large enough to separate the upper space from the lower space in the chamber 10. An exhaust path 410 is formed at the separation plate 400. Along the exhaust path 410, drying fluid such as the above-mentioned alcohol vapor and nitrogen gas is exhausted from a drying room 200 during a dry process. To uniformly supply the alcohol vapor or nitrogen gas to entire surfaces of the wafers “W” to be exhausted to the outside, the exhaust path 410 is preferably disposed at a central portion 430 of the separation plate 400. Optionally, the exhaust path 410 may be disposed at a lateral portion 440 of the separation plate 400.

The exhaust path 410 may comprise a plurality of circular holes formed at the separation plate 400. The holes are disposed in a row at the central portion 430 of the separation plate 400. Although the holes are disposed in a row as shown in FIG. 4, in other embodiments of the invention they may be disposed in a plurality of rows as shown in FIG. 5. The row of holes is vertical to a wafer “W” disposed at the supporter 300. Optionally, the holes may have different sizes according to their positions, as shown in FIG. 6, and the holes may be spaced at different intervals, as shown in FIG. 7.

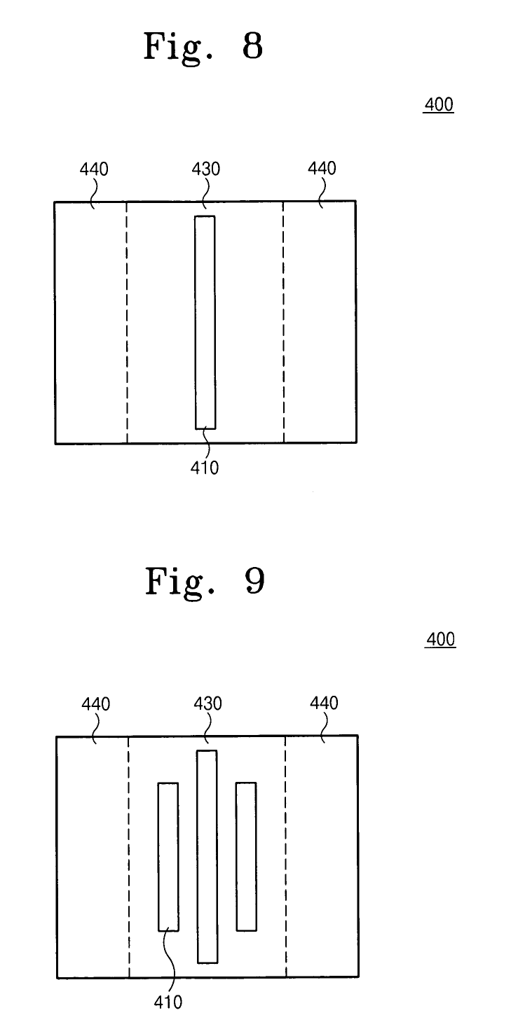

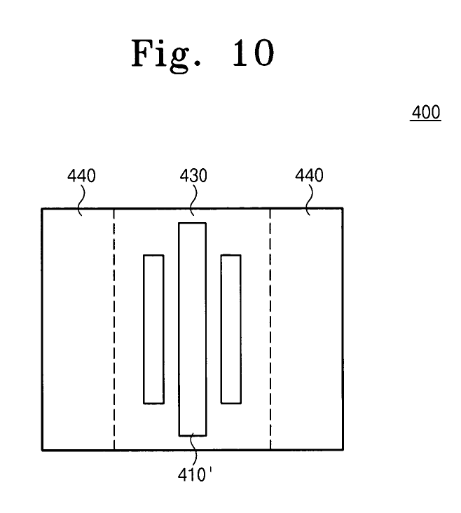

Another exemplary embodiment of the separation plate 400 is shown in FIG. 8, and various other exemplary embodiments of the separation plate 400 are shown in FIG. 9 and FIG. 10. An exhaust path 410 may be a slit formed at the separation plate 400. The slit is vertical to a wafer disposed at a central portion 430 of the separation plate 400. Although only one slit may be formed at the central portion 430 of the separation plate 400 as shown in FIG. 8, a plurality of slits may be formed as shown in FIG. 9. Optionally, the slits may have varying widths according to their position, as shown in FIG. 10. Alternatively, in other embodiments of the invention, the width of one slit may gradually change. Further, at the separation plate 400, a hole and a slit may be concurrently formed as the exhaust path 410.

When a drying fluid is supplied to a drying room 200, the inside of the drying room 200 must be decompressed to drain the drying fluid. According to various exemplary embodiments of the invention, when a wafer “W” is transferred to the drying room 200 and the drying room 200 and the cleaning room 100 are separated by the separation plate 400, the inside of the cleaning room 100 is filled with DI water. When alcohol vapor is supplied to the drying room 200, the DI water is drained to the outside through the drainpipe 660. As a surface of the DI water is gradually lowered in the inner bath 120 of the cleaning room 100, an empty space is formed in the cleaning room 120 to reduce the pressure of the drying room 200. The alcohol vapor supplied into the drying room 200 flows into the cleaning room 100 through the exhaust path 410 formed at the separation plate 400.

According to various exemplary embodiments of the invention, the drying room 200 is decompressed as the DI water in the inner bath 120 of the cleaning room 100 is drained during the drying process. Therefore, it is not necessary to install a special pump for decompressing the drying room 200.

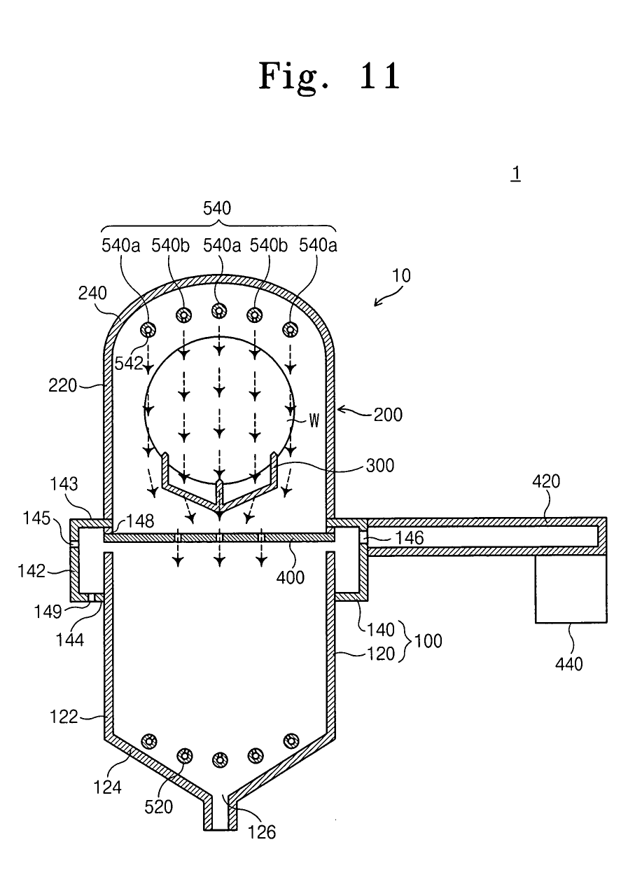

A flow of the drying fluid in the drying room 200 will now be described with reference to FIG. 11.

Referring to FIG. 11, a fluid supplied from the first supply pipe 540a or the second supply pipe 540b disposed over a wafer “W” flows down in a perpendicular direction. At a lower position of the cleaning room 200, the fluid flows to a central portion 430 of the separation plate 400 where an exhaust path 410 is formed. Since the exhaust path 410 is formed just below the wafer “W”, the fluid supplied to the drying room 200 may dry an entire surface from an upper edge to a lower edge of the wafer “W”. Further, since the exhaust path 410 is formed in a row perpendicular to the wafers “W”, all the wafers “W” may be uniformly dried.

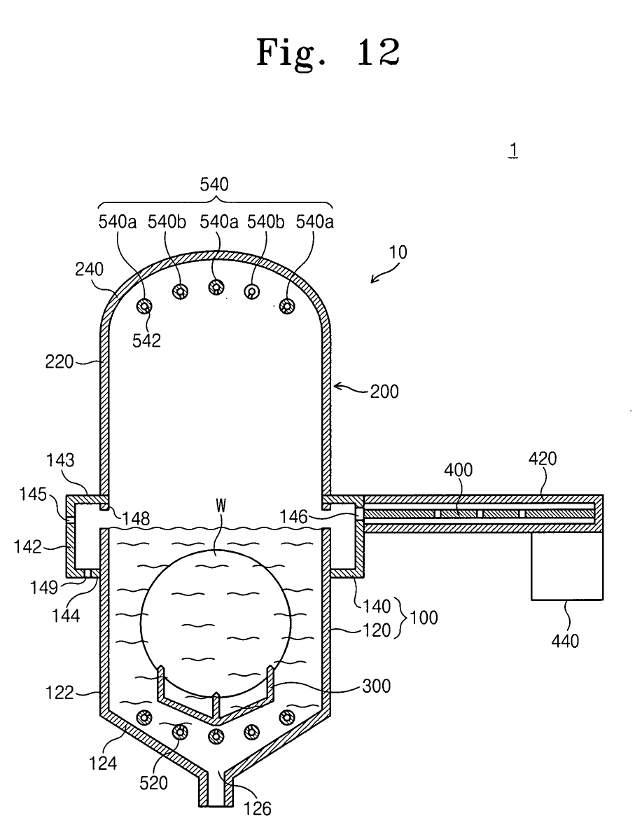

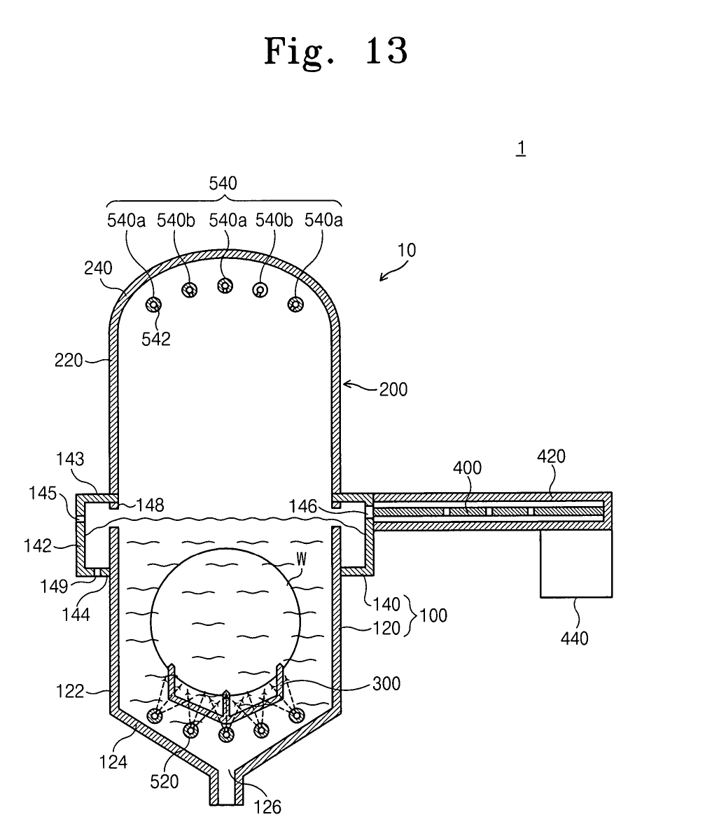

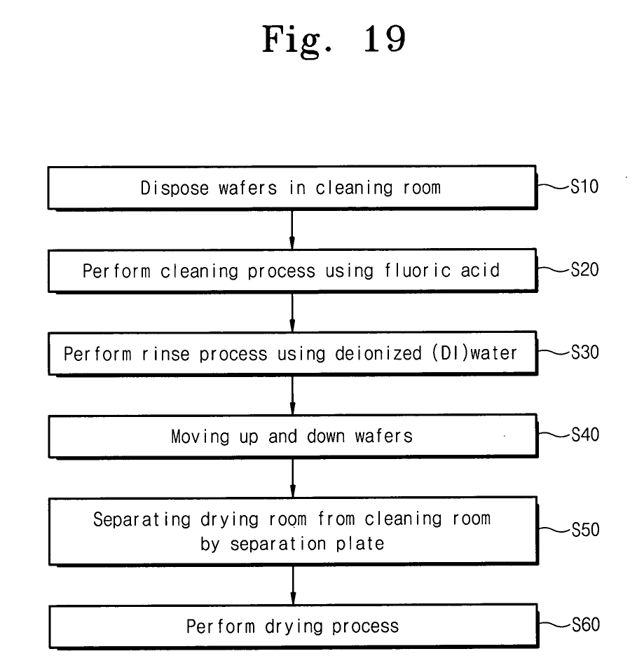

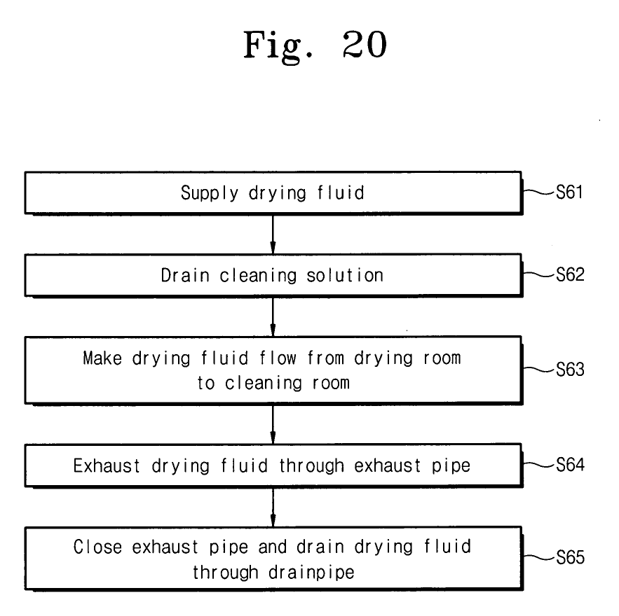

A cleaning process according to an exemplary embodiment of the invention will now be described with reference to FIG. 12 through FIG. 20. FIG. 12 through FIG. 18 are cross-sectional views showing a cleaning process according to an exemplary embodiment of the invention. FIG. 19 is a flowchart showing the steps of a cleaning process according to an exemplary embodiment of the present invention, and FIG. 20 is a flowchart showing the steps of a dry process according to an exemplary embodiment of the present invention.

After opening the top of the chamber 10, approximately 50 wafers “W” are transferred to the top of the chamber 10 by means of a transfer robot (not shown). In the cleaning room 100, a cleaning process is carried out to clean a wafer “W” using a chemical solution. The chemical solution may be, for example, fluoric acid. The drainpipe 660 is closed by means of the open/close valve 662 and DI water containing fluoric acid is supplied into the inner bath 120 from the cleaning solution supply pipe 520. While the supporter 300 is moved up, wafers 300 are inserted into slots of the supporter 300. As shown in FIG. 12, the supporter 300 is moved down in the cleaning room 100 by means of the supporter driving part 360 and the top of the chamber 10 is closed (S10). The DI water containing fluoric acid cleans surfaces of the wafers “W”. With the lapse of time, the DI water containing fluoric acid overflows from the inner bath 120. The overflowing DI water flows into an outer bath 140 surrounding the sidewall 122 of the inner bath 120 to be exhausted to the outside through a drainpipe 640 connected to a lower side 144 of the outer bath 140 (S20).

When the cleaning process is completed by a chemical solution, a rinse process starts to remove the chemical solution attached to the surface of the wafer “W”. The DI water is supplied from the cleaning solution supply pipe 520 to the inner bath 120. The DI water is continuously supplied for a predetermined time to overflow from the inner bath 120. The overflowing DI water flows into the outer bath 140, and is then drained to the outside through the drainpipe 640 (see FIG. 13, S30).

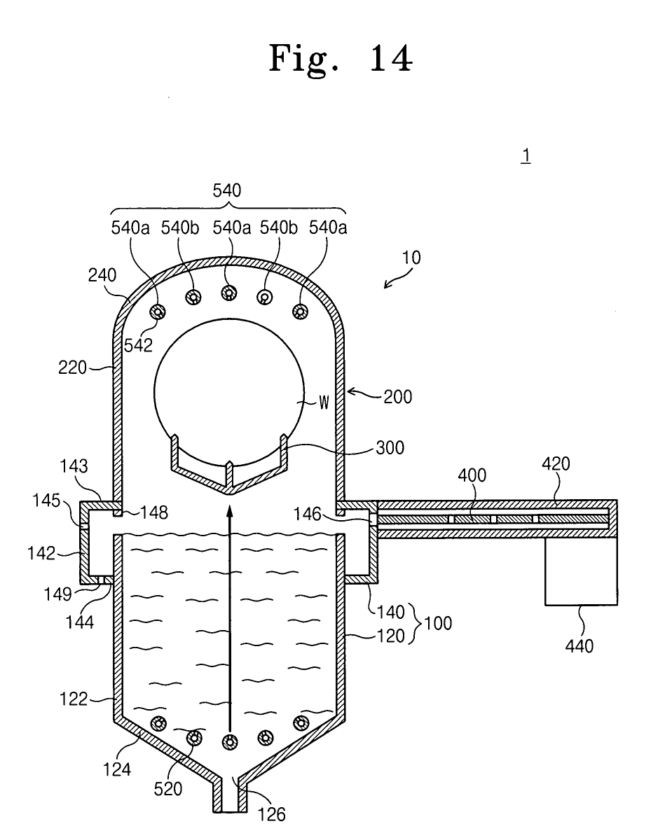

When the rinse process is completed, the wafers “W” are transferred to the drying room 200 by moving up the supporter 300 (see FIG. 14, S40). In this case, the supporter 300 is moved up by means of the supporter driving part 380. After stopping the supply of the DI water, the wafers “W” may be moved up. Since a surface of the DI water is lowered when the wafers “W” are moved up, DI water may be supplied from the cleaning solution supply pipe 520 for a determined time while the wafers “W” are moved up.

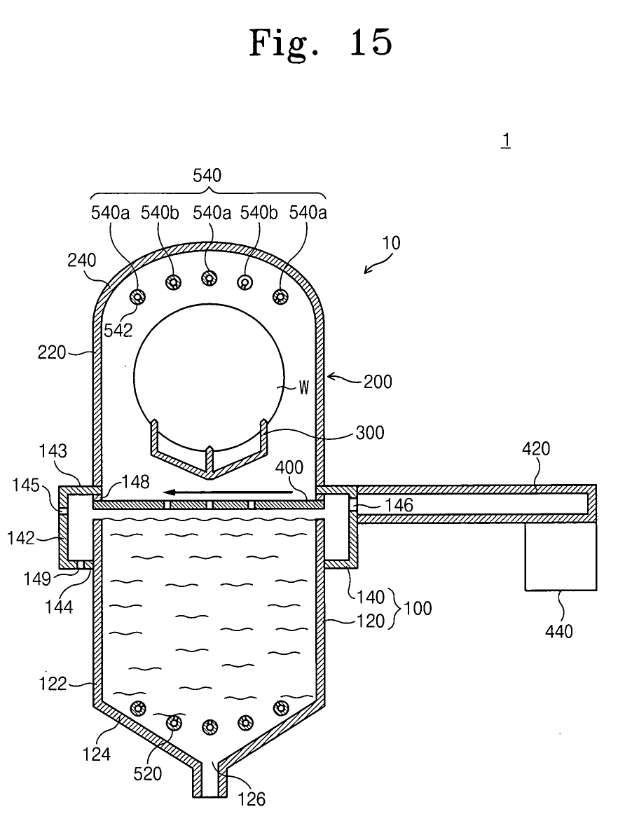

The amount of DI water in the inner bath 120 is maintained at a full level. The separation plate 400 accommodated in a separation plate accommodating part 420 is moved between the drying room 200 and the cleaning room 100 to separate the drying room 200 from the cleaning room 100 (see FIG. 15, S50).

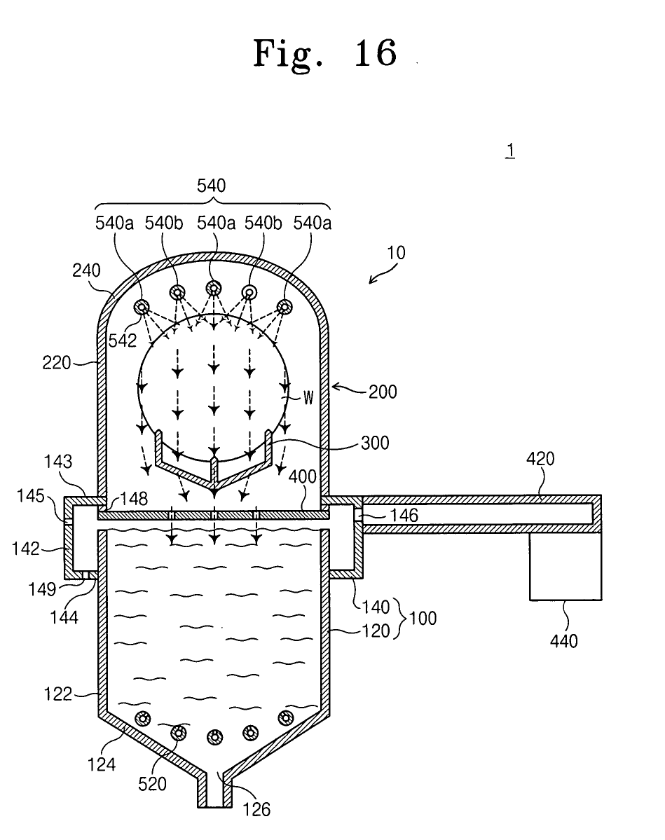

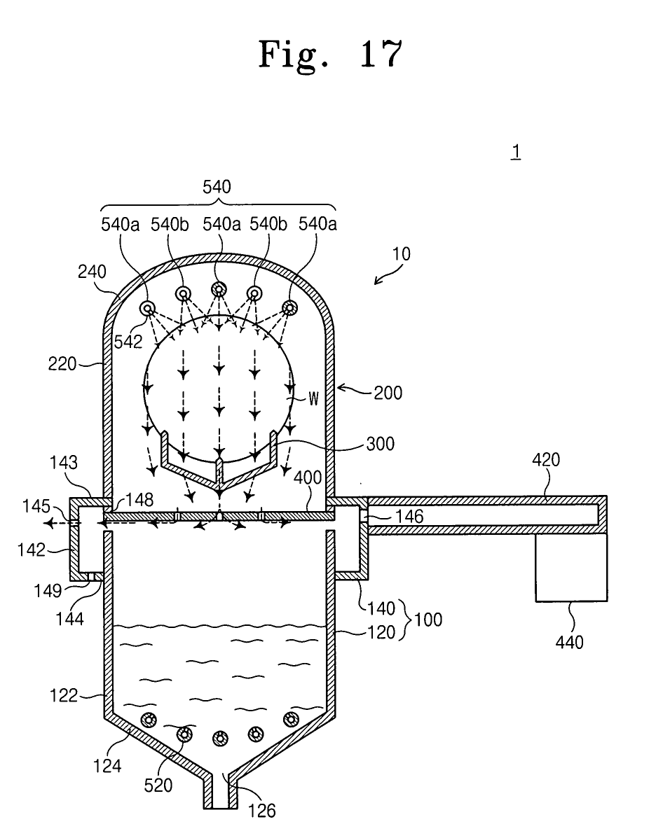

A process for drying wafers is carried out (S60). IPA vapor is supplied from the first supply pipe 540a installed at the upper portion of the drying room 200 into the drying room 200. The DI water attached onto the surfaces of the wafers “W” are substituted by the IPA vapor. To dry the surfaces of the wafers “W”, heated nitrogen gas is supplied from the second supply pipe 540b installed at the upper portion of the drying room 200 (see FIG. 16, S61). During the dry process, a passage of the drainpipe 660 connected to the inner bath 120 is opened to slowly drain the DI water filling the inner bath 120 (see FIG. 17, S62). In this case, the DI water is preferably drained by gravity. As the ID water is drained from the inner bath 120, the surface of the DI water therein is gradually lowered. Thus, an empty space increases in size in the inner bath 120 and an internal pressure of the drying room 200 is reduced. Gases filling the drying room 200 are exhausted to the cleaning room 100 through an exhaust path 410 (S63).

Since the exhaust path 410 is formed at the central portion 430 of the separation plate 400, the alcohol vapor injected onto the wafers “W” sequentially flows to an upper edge, a central portion, and a lower edge of the wafers “W” and then is exhausted from the exhaust path 410 from the drying room 200. Therefore, an entire processing surface of the wafer “W” is uniformly dried. Further, since the drying room 200 is decompressed as the surface of the DI water in the cleaning room 100 is lowered, it is not necessary to install a special pump. Optionally, a pump (not shown) for draining a drying fluid to the sidewall 220 of the drying room 200 may be used.

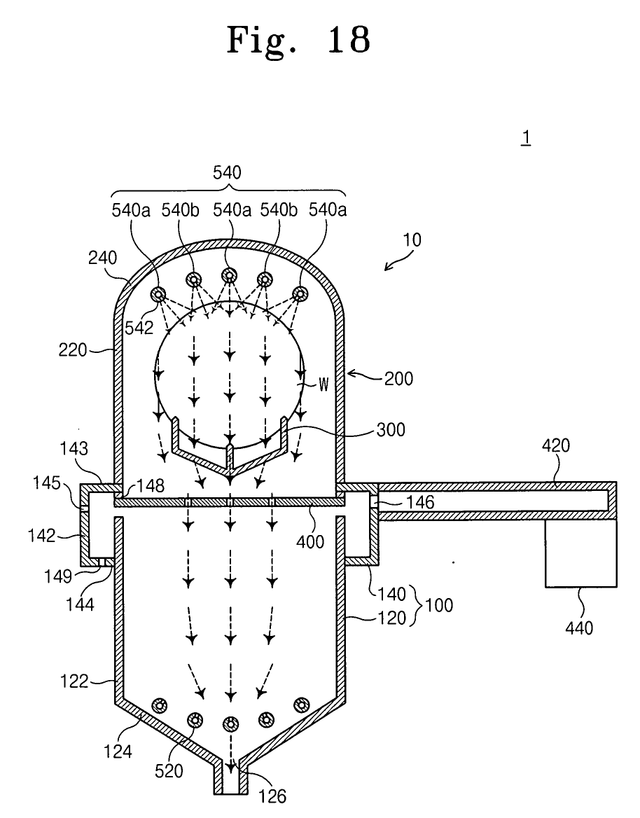

While the cleaning solution is not completely exhausted from the inner bath 120, a passage of an exhaust pipe 620 connected to the exhaust port 145 formed at the sidewall 142 of the outer bath 140 is opened and the drying fluid flowing into the cleaning room 100 is exhausted to the outside through the exhaust pipe 620 (S64). When the cleaning solution is completely exhausted from the inner bath 120, the drying fluid flowing into the cleaning room 100 is drained to the outside through the drainpipe 660 (see FIG. 18, S65).

According to various exemplary embodiments of the present invention, an exhaust path is formed just below the wafers to uniformly dry all wafers. Without using a special pump, drying fluids supplied to a drying room are drained. A chemical solution treating process, a rinse process, and a dry process are performed in one chamber to shorten the time required for performing these processes.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for cleaning semiconductor substrates by using a chamber including a cleaning room in which the substrates are cleaned and a drying room in which the substrates are dried, the method comprising the steps of:
disposing the substrates in the cleaning room;
supplying a cleaning solution to the cleaning room to clean the substrates;
moving a supporter, in which the substrates are placed, to the drying room;
moving a separation plate, in which an exhaust path is formed, between the cleaning room and the drying room to separate the drying room from the cleaning room; and
supplying a drying fluid to the drying room to dry the substrates.

2. The method of claim 1, wherein the step of drying the substrates comprises the steps of:
draining the cleaning solution filling the cleaning room to the outside to decompress the inside of the drying room; and
exhausting the drying fluid supplied to the drying room from the drying room through the exhaust path formed in the separation plate.

3. The method of claim 2, wherein the step of drying the substrates further comprises a step of exhausting the drying fluid flowing into the cleaning room through an exhaust port formed at the sidewall of the cleaning room while the cleaning solution is drained through a drainpipe of the cleaning room.

4. The method of claim 3, wherein the step of drying the substrates further comprises the steps of:
closing the exhaust port when the cleaning solution is completely drained from the cleaning room; and
exhausting the drying fluid flowing into the cleaning room through the drainpipe of the cleaning room.

5. The method of claim 4, wherein the drainpipe is connected to the bottom of the cleaning room, and the drain of the cleaning solution from the cleaning room is achieved by gravity.

6. The method of claim 1, wherein the step of drying the substrates comprises the steps of:
supplying alcohol vapor onto the substrate; and
supplying a heated dry gas onto the substrate.

7. The method of claim 6, wherein the alcohol vapor is isopropyl alcohol, and the dry gas is nitrogen gas.

8. An apparatus for cleaning semiconductor substrates, comprising:
a chamber having a cleaning room in which the semiconductor substrates are cleaned and a drying room, disposed over the cleaning room, in which the semiconductor substrates are dried;
a supporter disposed in the chamber that supports the semiconductor substrates;
a supply pipe installed at an upper portion of the drying room that supplies a drying fluid onto the substrate; and
a separation plate which is movable to separate the cleaning room and the drying room or to place the cleaning room and the drying 15 room in communication with one another, an exhaust path of the drying fluid being formed in the separation plate, wherein, as cleaning solution filling the cleaning room is drained to the outside, the inside of the drying room is decompressed and the drying fluid supplied to the drying room flows from the drying room to the cleaning room through the exhaust path of the separation plate.

9. The apparatus of claim 8, wherein the supply pipe comprises:
a first supply pipe for supplying alcohol vapor into the drying room; and
a second supply pipe for supplying a heated dry gas into the drying room.

10. The apparatus of claim 9, further comprising a cleaning solution supply pipe disposed in the cleaning room that injects the cleaning solution into the cleaning room,
wherein the cleaning room further comprises:
an inner bath where the supporter is disposed; and
an outer bath disposed to surround the upper outer periphery of the inner bath,
wherein the cleaning solution overflowing from the inner bath flows into the outer bath, and a drain port is formed at the bottom of the outer bath.

11. The apparatus of claim 10, wherein an exhaust port is formed at one side of the outer bath, and the drying fluid flowing into the cleaning room along the exhaust path of the separation plate is exhausted to the outside through the exhaust port.

12. The apparatus of claim 10, wherein the separation plate further comprises a separation plate moving part having a connecting rod fixedly connected to the separation plate and a driving part for horizontally moving the connecting rod.

13. The apparatus of claim 8, wherein the exhaust path comprises at least one hole or slit formed in the separation plate.

14. The apparatus of claim 13, wherein the at least one hole or slit comprises a plurality of holes and slits, and the plurality of holes or slits are formed in the separation plate, and sizes of the holes or widths of the slits differ according to their positions.

15. The apparatus of claim 13, wherein the at least one hole or slit comprises a plurality of holes or slits, and the plurality of holes or slits are formed in at least one row at the central portion of the separation plate.

16. The apparatus of claim 15, wherein spaces between adjacent holes differ according to their forming positions.

17. The apparatus of claim 13, wherein the semiconductor substrates are placed in a row, and the row direction is vertical to processing surfaces of the semiconductor substrates.

18. An apparatus for cleaning semiconductor substrates, comprising:
a chamber having a drying room in which the semiconductor substrates are dried;
a supply pipe installed in the drying room that supplies drying fluid onto the semiconductor substrates; and
a separation plate constituting a bottom of the drying room,
wherein an exhaust path is formed at a central portion of the separation plate, and
wherein the drying fluids supplied onto the substrate are exhausted from the drying room through the exhaust path.

19. The apparatus of claim 18, wherein the chamber further comprises a cleaning room, disposed below the drying room and separated from the drying room by the separation plate, in which the substrate is cleaned, and the separation plate is movably disposed.

20. An apparatus for cleaning semiconductor substrates, comprising:
a chamber comprising:
a cleaning room in which the semiconductor substrates are cleaned; and
a drying room, disposed over the cleaning room, in which the semiconductor substrates are dried; and
a separation plate that is movable between an open position in which the cleaning room is in communication with the drying room and a closed position in which the cleaning room is separated from the drying room.

21. The apparatus of claim 20, further comprising:
a supporter disposed in the chamber that supports the semiconductor substrates.

22. The apparatus of claim 21, further comprising:
a supply pipe installed in the drying room that supplies a drying fluid onto the semiconductor substrates,
wherein an exhaust path of the drying fluid is formed in the separation plate, and
as cleaning solution filling the cleaning room is drained to the outside, the inside of the drying room is decompressed and the drying fluid supplied to the drying room flows from the drying room to the cleaning room through the exhaust path of the separation plate.

23. The apparatus of claim 20, wherein the separation plate further comprises a separation plate moving part having a connecting rod fixedly connected to the separation plate and a driving part for horizontally moving the connecting rod.

24. The apparatus of claim 22, wherein the supply pipe comprises:
a first supply pipe for supplying alcohol vapor into the drying room; and
a second supply pipe for supplying a heated dry gas into the drying room.

25. The apparatus of claim 22, further comprising a cleaning solution supply pipe disposed in the cleaning room that injects the cleaning solution into the cleaning room,
wherein the cleaning room further comprises:
an inner bath where the supporter is disposed; and
an outer bath disposed to surround the upper outer periphery of the inner bath,
wherein the cleaning solution overflowing from the inner bath flows into the outer bath, and a drain port is formed at the bottom of the outer bath.

26. The apparatus of claim 25, wherein an exhaust port is formed at one side of the outer bath, and the drying fluid flowing into the cleaning room along the exhaust path of the separation plate is exhausted to the outside through the exhaust port.
